(19) United States
(12) Patent Application Publication
(10) Pub. No.: US 2025/0037914 A1
(43) Pub. Date: Jan. 30, 2025

(54) COIL COMPONENT

(71) Applicant: SAMSUNG ELECTRO-MECHANICS CO., LTD., Suwon-si (KR)

(72) Inventors: Jin Young KIM, Suwon-si (KR); Kang Wook BONG, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/609,321

(22) Filed: Mar. 19, 2024

(30) Foreign Application Priority Data
Jul. 27, 2023 (KR) 10-2023-0098076

(51) Int. Cl. H01F 5/02; H01F 5/04; H01F 27/28; H01F 41/082

(52) U.S. Cl. CPC H01F 5/02; H01F 5/04; H01F 27/2804; H01F 41/082

(57) ABSTRACT

A coil component includes a body having a first surface, a second surface opposing the first surface in a first direction, and a plurality of side surfaces connecting the first surface and the second surface, a coil embedded in the body, and a support member embedded in the body and including a support portion supporting the coil and at least one stopper portion disposed at a corner formed by two or more of the plurality of side surfaces of the body in an outer region of the support portion.

### CROSS-REFERENCE TO RELATED APPLICATION(S)

This application claims benefit of priority to Korean Patent Application No. 10-2023-0098076 filed on Jul. 27, 2023 in the Korean Intellectual Property Office, the disclosure of which is incorporated herein by reference in its entirety.

### TECHNICAL FIELD

The present disclosure relates to a coil component.

Inductors, coil components, are representative passive electronic components used in electronic devices along with resistors and capacitors.

As electronic devices have improved to have high performance and efficiency, miniaturized (low profile) and highly efficient products have been required for chip inductor components.

### SUMMARY

An aspect of the present disclosure is to provide a coil component in which a coil is prevented from being deformed during a process of stacking and compressing magnetic composite sheets.

Another aspect of the present disclosure is to provide a coil component that may be thinned (low-profile), while reducing a defect rate due to coil deformation.

According to an aspect of the present disclosure, a coil component includes: a body having a first surface, a second surface opposing the first surface in a first direction, and a plurality of side surfaces connecting the first surface and the second surface; a coil embedded in the body; and a support member embedded in the body and including a support portion supporting the coil and at least one stopper portion disposed at a corner formed by two or more of the plurality of side surfaces of the body in an outer region of the support portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first exemplary embodiment in the present disclosure;

FIG. 2 is a plan view schematically illustrating a coil component according to the first exemplary embodiment in the present disclosure;

FIG. 3 is an enlarged view of portion A of FIG. 2;

FIG. 4 is a plan view illustrating a modified example of the coil component according to the first exemplary embodiment in the present disclosure;

FIG. 5 is a plan view illustrating another modified example of the coil component according to the first exemplary embodiment in the present disclosure;

FIG. 6 is a perspective view schematically illustrating a coil component according to a second exemplary embodiment in the present disclosure;

FIG. 7 is a plan view schematically illustrating a coil component according to the second exemplary embodiment in the present disclosure;

FIG. 8 is a plan view illustrating a modified example of the coil component according to the second exemplary embodiment in the present disclosure;

FIG. 9 is a plan view illustrating another modified example of the coil component according to the second exemplary embodiment in the present disclosure;

FIG. 10 is a perspective view illustrating another modified example of the coil component according to the second exemplary embodiment in the present disclosure; and

FIG. 11 is a diagram illustrating a related art coil component as a comparative example.

### DETAILED DESCRIPTION

The terms used in the present specification are merely used to describe particular exemplary embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but It should be used as a concept that encompasses even a case in which another component intervenes between each component so that a component is in contact with the other component.

Since the size and thickness of each component illustrated in the drawings are arbitrarily illustrated for convenience of description, the present disclosure is not necessarily limited to the illustrated.

In the drawing, the X-direction may be defined as a first direction or thickness direction, the Y-direction may be defined as a second direction or length direction, and the Z-direction may be defined as a third direction or width direction.

Hereinafter, a coil component according to an exemplary embodiment in the present disclosure will be described in detail with reference to the accompanying drawings, and in the description with reference to the accompanying drawings, the same or corresponding components are assigned the same reference numerals and redundant descriptions thereof will be omitted.

Various types of electronic components are used in electronic devices, and various types of coil components may be appropriately used in these electronic components for purposes, such as noise removal.

In other words, coil components in electronic devices may be used as power inductors, high frequency (HF) inductors, general beads, GHz beads, common mode filters, and the like.

### First Exemplary Embodiment

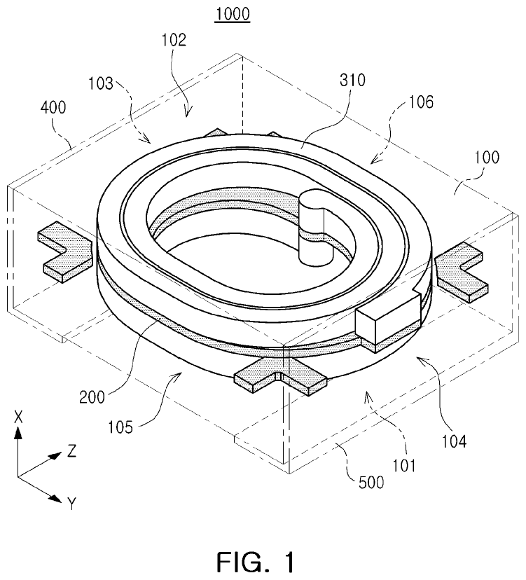

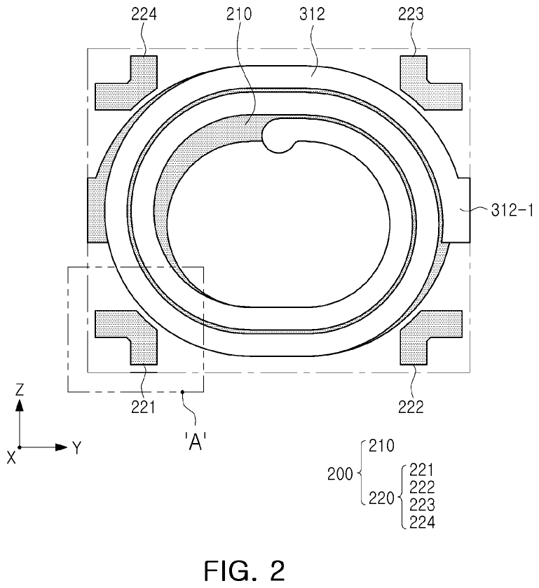

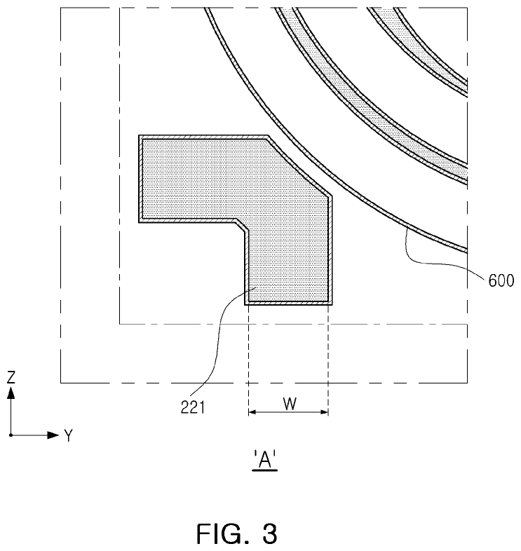

FIG. 1 is a perspective view schematically illustrating a coil component according to a first exemplary embodiment in the present disclosure. FIG. 2 is a plan view schematically illustrating the coil component according to the first exemplary embodiment in the present disclosure. FIG. 3 is an enlarged view of portion A of FIG. 2.

Referring to FIGS. 1 to 3, a coil component 1000 according to the first exemplary embodiment in the present disclosure includes a body 100, a support member 200, a coil 310, and external electrodes 400 and 500 and may further include an insulating film 600.

The body 100 forms the exterior of the coil component 1000 according to the present exemplary embodiment, and the support member 200 and the coil 310 are embedded in the body 100.

The body 100 may have a hexahedral shape as a whole.

Referring to FIGS. 1 to 3, the body 100 includes a first surface 101 and a second surface 102 opposing each other in a first direction (an X-direction), first side surface 103 and a second side surface 104 opposing each other in a second direction (a Y-direction), and a third side surface 105 and a fourth side surface 106 opposing each other in a third direction (a Z-direction). The first to fourth side surfaces 103, 104, 105, and 106 correspond to a plurality of side surfaces connecting the first side surface 101 and the second side surface 102.

The body 100 may include a plurality of corners. Specifically, the body may include four corners at which two adjacent side surfaces, among the plurality of side surfaces 103, 104, 105, and 106, contact each other.

among the plurality of side surfaces 103, 104, 105, and 106 of the body, two adjacent sides may include four edges in contact with each other. Since the plurality of side surfaces meet vertically, the four corners may form right angles but are not limited thereto. For example, the angle formed depending on the number of side surfaces may not be a right angle, and the corners may be rounded through a polishing process.

By way of example, the body 100 is formed so that the coil component 1000 according to the present exemplary embodiment on which the external electrodes 400 and 500, which will be described below, are formed, may be formed to have a length of 2.0 mm, a width of 1.2 mm, and a thickness of 0.65 mm, but is not limited thereto.

The body 100 may include a magnetic material and an insulating resin. Specifically, the body 100 may be formed by stacking one or more magnetic composite sheets including an insulating resin and a magnetic material dispersed in the insulating resin. However, the body 100 may have a structure other than the structure in which a magnetic material is dispersed in an insulating resin. For example, the body 100 may be formed of a magnetic material, such as ferrite.

The magnetic material may be magnetic powder particles, for example, ferrite or magnetic metal powder particles.

The ferrite powder particles may be at least one of, for example, Mg—Zn-based, Mn—Zn-based, Mn—Mg-based, Cu—Zn-based, Mg—Mn—Sr-based, Ni—Zn-based spinel ferrite, Ba—Zn-based, Ba—Mg-based, Ba—Ni-based, Ba—Co-based, and Ba—Ni—Co-based hexagonal ferrites, garnet-type ferrites, such as Y-based ferrites, and Li-based ferrites.

The magnetic metal powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The magnetic metal powder particles may be amorphous or crystalline. For example, the magnetic metal be powder particles may Fe—Si—B—Cr-based amorphous alloy powder particles, but are not limited thereto.

Each of the ferrite and magnetic metal powder particles may have an average diameter of about 0.1 μm to about 30 μm, but is not limited thereto.

The body 100 may include two or more types of magnetic powder particles dispersed in the insulating resin. Here, the different types of magnetic powder particles means that the magnetic powder particles dispersed in the insulating resin are distinguished from each other by one of diameter, composition, crystallinity, and shape. For example, the body 100 may include two or more magnetic powder particles having different diameters.

The insulating resin may include epoxy, polyimide, liquid crystal polymer, etc. alone or in combination, but is not limited thereto.

The body 100 includes a core 110 penetrating through the coil 310 to be described below. The core 110 may be formed by filling a through-hole of the coil unit 300 with the magnetic composite sheet, but is not limited thereto.

The support member 200 is embedded in the body 100. The support member 200 supports the coil 310 to be described below.

The support member 200 may be formed of an insulating material including a thermosetting insulating resin, such as an epoxy resin, a thermoplastic insulating resin, such as polyimide, or a photosensitive insulating resin, or an insulating material impregnated with a reinforcing material, such as glass fiber or inorganic filler in such an insulating resin. For example, the support member 200 may be formed of an insulating material, such as prepreg, Ajinomoto build-up film (ABF), FR-4, bismaleimide triazine (BT) film, photo imageable dielectric (PID) film, but is not limited thereto.

As inorganic fillers, at least one selected from the group consisting of silica (SiO₂), alumina (Al₂O₃), silicon carbide (SiC), barium sulfate (BaSO₄), talc, clay, mica powder particles, aluminum hydroxide (AlOH₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide superior rigidity. When the support member 200 is formed of an insulating material that does not contain glass fibers, the support member 200 is advantageous in reducing the overall thickness of the coil 310. When the support member 200 is formed of an insulating material including a photosensitive insulating resin, the number of processes for forming the coil 310 may be reduced, which is advantageous in reducing production costs, and it is possible to form fine vias.

The support member 200 includes a support portion 210 supporting the coil 310, which will be described below, and at least one stopper portion 220 disposed at the corner of the body 100 in an outer region of the support portion 210. The support portion 210 is a member supporting first and second coil patterns 311 and 312 of the coil 310 and the end portion (corresponding to 312-1, although not labeled in the drawings) of the first coil pattern and the end portion 312-1 of the second coil pattern, and may be formed in a shape corresponding to the shape of the second coil patterns 311 and 312 and the end portions 312-1 of the first and second coil patterns. As will be described below, the stopper portion 220 may prevent deformation of the coil occurring during the processing of stacking the magnetic composite sheet.

Referring to FIGS. 2 and 3, the stopper portion 220 is disposed at a corner of the body 100 in the outer regions of the support portion 210. Here, the outer region of the support portion 210 may refer to a region between the region in which the support portion 210 is formed and a plurality of side surfaces of the body 100. Being disposed at a corner of the body 100 may refer to being disposed adjacent to a region (i.e., a corner) at which two adjacent side surfaces, among the plurality of side surfaces 103, 104, 105, and 106, contact each other.

A plurality of stopper portions 220 may be formed to be adjacent to each corner formed by a plurality of side surfaces of the body. Specifically, the stopper portion 220 may include a first stopper portion 221 adjacent to the corner formed by the first side surface 103 and the third side surface 105 of the body, a second stopper portion 222 adjacent to the corner formed by the second side surface 104 and the third side surface 105 of the body, a third stopper portion 223 adjacent to the corner formed by the second side surface 104 and the fourth side surface 106 of the body, and a fourth stopper portion 224 adjacent to the corner formed by the first side surface 103 and the fourth side surface 106 of the body. In this case, when a plurality of stopper portions 220 are arranged to be adjacent to each corner formed by the plurality of side surfaces of the body, stress applied to the support member 200 and the coil 310 may be equally dispersed to the body 100, when the body 100 is formed, thereby minimizing deformation of the coil 310.

The plurality of stopper portions 221, 222, 223, and 224 may be formed to be symmetrical to each other. Here, ‘symmetry’ is a concept including not only plane symmetry but also point symmetry. Referring to FIG. 2, the first stopper portion 221 and the second stopper portion 222 may have a plane symmetry relationship with respect to a plane parallel to the X-Z plane. Similarly, the fourth stopper portion 224 and the third stopper portion 223 may also have a plane symmetry relationship with respect to a plane parallel to the X-Z plane. The first stopper portion 221 and the fourth stopper portion 224 may have a plane symmetry relationship with respect to a plane parallel to the X-Y plane. Similarly, the second stopper portion 222 and the third stopper portion 223 may also have a plane symmetry relationship with respect to a plane parallel to the X-Y plane. The first stopper portion 221 and the third stopper portion 223 may have a point symmetric relationship, and the second stopper portion 222 and the fourth stopper portion 224 may have a point symmetry relationship.

The stopper portion 220 may have an ‘L’ shape. Specifically, the stopper portion 220 may have an L-shape to form a rectangular shape with the corner of the body 100 adjacent thereto. That is, a region in which the support member 200 is not disposed occurs between the stopper portion 220 and the corner of the body 100 adjacent thereto, and only the body may exist in the corresponding space. For example, a respective stopper portion 220 may include a first portion extending toward one of the side surfaces of the body 100, a second portion extending toward another of the side surfaces of the body 100, and a connection portion connecting the first portion and the second portion to each other and disposed closer to the support member 210 than the first and second portions. By disposing portion of the body between the stopper portion 220 and the corner of the body 100 adjacent thereto in this manner, flow of magnetic flux may be smoothened.

The stopper portion 220 may not extend to the plurality of side surfaces of the body. That is, the stopper portion 220 may be completely embedded within the body 100. In this case, as will be described below, the metal layer 320 formed on the stopper portion 220 may be prevented from being pushed away (plating spread phenomenon) during a dicing process of the coil component. However, the present disclosure is not limited thereto, and the stopper portion 220 may extend to a plurality of side surfaces of the body.

The stopper portion 220 of the coil component according to the present exemplary embodiment may function as a region indirectly supporting the coil 310. That is, the stopper portion 220 serves to assist the support portion 310 directly supporting the coil, when stacking magnetic composite sheets. Specifically, as the coil component 1000 becomes thinner, the pressure and temperature applied when forming the body 100 of the coil component 1000 may increase, thereby increasing the possibility of deformation of the coil 310. In the case of the present exemplary embodiment, by forming the stopper portion 220, stress applied to the coil 310 and the support portion 210 when forming the body 100 may be reduced. That is, as an example, a portion of the magnetic composite sheet for forming the body 100 may flow into a gap (space) between the stopper portion 220 and the corner of the body 100, thereby minimizing deformation of the support portion 210. In this manner, the region capable of supporting the coil may be increased through the introduction of the stopper portion 220, thereby preventing deformation of the coil.

In addition, the stopper portion 220 may connect adjacent coil units to each other when stacking magnetic composite sheets, thereby preventing deformation of each coil unit.

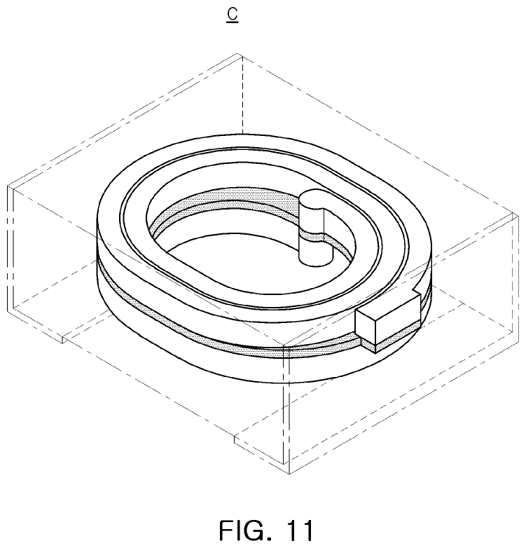

The stopper portion 220 may have a width of 30 μm or more and 500 μm or less. As described above, the stopper portion 220 has an ‘L’ shape, and thus, a width W of the stopper portion 220 may be obtained by measuring a length in the second direction (the Y-direction) or the third direction (Z). A specific method is as follows. First, a coil component is polished to a depth of about ½ in the first direction (the X-direction) to prepare a sample with an exposed cross-section. Next, when observing the collected cross-sectional sample with an optical microscope, etc., the stopper portion 220 may be observed, and the width of the stopper portion 220 may be measured by measuring the length in the second direction (the Y-direction) or the third direction (the Z-direction).

[Table 1] below shows the occurrence of coil deformation defects depending on the width of the stopper portion 220. No. 1 is the related art coil component (FIG. 11) in which the stopper portion 220 is not formed as a comparative example.

TABLE 1

| No. | Numerical value (μm) | Deformation (exposure) defect |
|---|---|---|
| 1 | 0 | Occurred |
| 2 | 10 | Occurred |
| 3 | 30 | OK |
| 4 | 100 | OK |
| 5 | 300 | OK |
| 6 | 400 | OK |
| 7 | 500~ | OK |

Referring to [Table 1], if the stopper portion 220 is not formed (No. 1) or the width is less than 30 μm (No. 2), a deformation defect of the coil 310 occurs. That is, when forming the body 100, the coil 310 may be deformed due to stress applied to the coil 310 and the support member 200. If the width of the stopper portion 220 exceeds 500 μm, the size of the coil component may become too large, making it difficult to manufacture thin/small coil components. Therefore, as a coil component according to the present exemplary embodiment, the width of the stopper portion 220 is proposed to be 30 μm or more and 500 μm or less.

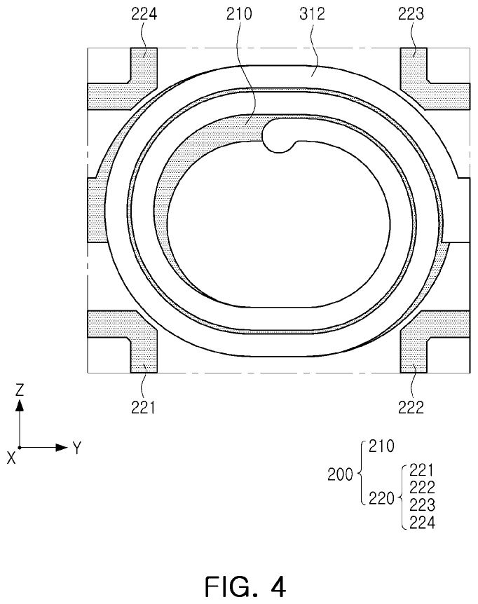

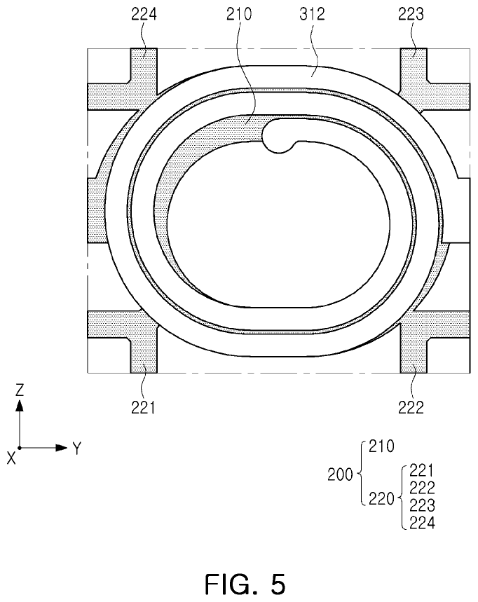

FIGS. 4 and 5 are plan views illustrating a modified example of the coil component according to the first exemplary embodiment.

Referring to FIGS. 4 and 5, the stopper portion 220 may extend to one of the plurality of side surfaces 103, 104, 105, and 106 of the body. Specifically, the stopper portion 220 may extend to any two adjacent side surfaces among the plurality of side surfaces 103, 104, 105, and 106 of the body. More specifically, the stopper portion 220 may extend to the first side surface 103 and the third side surface 105, may extend to the second side surface 104 and the third side surface 105, may extend to the second side surface 104 and the fourth side surface 106, and may extend to the first side surface 103 and the fourth side surface 106.

This is because the stopper portion 220 may be a region connecting coil units to each other when stacking magnetic composite sheets. The stopper portions 221, 222, 223, and 224 adjacent to the corners of the body 100 may be formed to connect the support member 210 to the support member 210 of another adjacent coil unit, and then may be separated from the other adjacent coil unit through a process of individualizing the coil unit. At this time, the stopper portion 220 may be exposed to a plurality of side surfaces of the body 100 of the coil component 1000. However, the present disclosure is not limited thereto, and as described above, the stopper portion 220 may be completely embedded within the body 100. That is, the stopper portion 220 may not extend to the plurality of side surfaces 103, 104, 105, and 106 of the body.

The surfaces of the stopper portion 220 extending to two adjacent side surfaces of the body may be spaced apart from each other. Referring to FIG. 4, the first stopper portion 221 may extend to the first side surface 103 and the third side surface 105 of the body, and here, the surfaces of the first stopper portion 221 extending to the first side surface 103 and the third side surface 105 of the body may be spaced apart from each other. That is, a gap may occur between the first stopper portion 221 and the corner formed by the first side surface 103 and the third side surface 105 of the body. As described above, flow of magnetic flux may be smoothed by disposing a portion of the body in the gap between the stopper portion 220 and the corner of the body.

Referring to FIG. 5, the stopper portion 220 may be connected to the support portion 210. That is, the stopper portion 220 and the support portion 210 may be formed integrally. When the stopper portion 220 is formed integrally with the support portion 210, the amount of support member 200 removed when manufacturing coil components may be minimized. In addition, since the stopper portion 220 is connected to the coil 310 through the support portion 210, stress applied to the coil 310 when forming the body 100 may be more effectively reduced.

The coil 310 is embedded in the body 100 and exhibits the characteristics of a coil component. For example, when the coil component 1000 of the present exemplary embodiment is used as a power inductor, the coil 310 may store an electric field as a magnetic field and maintain an output voltage, thereby serving to stabilize power of an electronic device.

The coil 310 includes the coil patterns 311 and 312 and vias. Specifically, based on the direction of FIG. 1, the first coil pattern 311 and the end portion of the first coil pattern 311 are disposed on one surface (the lower surface) of the support portion 210, and the second coil pattern 312 and the end portion 312-1 of the second coil pattern 312 are disposed on the other surface (the upper surface) of the support portion 210. The via may pass through the support portion 210 and contact each of the first coil pattern 311 and the second coil pattern 312. Accordingly, the coil 310 may function as a single coil forming one or more turns around the core 110 as a whole.

Each of the first coil pattern 311 and the second coil pattern 312 may have a planar spiral shape with at least one turn about the core 110. For example, the first coil pattern 311 may form at least one turn about the core 110 on the lower surface of the support portion 210.

At least one of the via and the coil patterns 311 and 312 may include one or more conductive layers. For example, when the second coil pattern 312, the end portion 312-1 of the second coil pattern 312, and the via are formed on the other surface of the support portion 210 by plating, the second coil pattern 312, the end portion 312-1 of the second coil pattern 31, and the via may each include a seed layer, such as an electroless plating layer, and an electroplating layer. Here, the electroplating layer may have a single-layer structure or a multi-layer structure. The electroplating layer having a multi-layer structure may be formed as a conformal film structure in which one electroplating layer is covered by another electroplating layer, or may be formed so that another electroplating layer is stacked only on one surface of one electroplating layer. The seed layer of the second coil pattern 312, the seed layer of the end portion 312-1 of the second coil pattern 312, and the seed layer of the via may be formed integrally, so that no boundary is formed therebetween, but the present disclosure is not limited thereto. The electroplating layer of the second coil pattern 312, the electroplating layer of the end portion 312-1 of the second coil pattern 312, and the electroplating layer of the via may be formed integrally, so that no boundary may be formed therebetween, but the present disclosure is not limited thereto.

As another example, when, based on the direction of FIG. 1, the first coil pattern 311 and the end portion disposed on the lower surface of the support portion 210 and the second coil pattern 312 and the end portion 312-1 disposed on the upper surface of the support portion 210 are separately formed and collectively stacked on the support portion 210 to form the coil 310, the via may include a high melting point metal layer and a low melting point metal layer having a melting point lower than that of the high melting point metal layer. Here, the low melting point metal layer may be formed of solder including lead (Pb) and/or tin (Sn). At least portion of the low melting point metal layer may be melted due to pressure and temperature during the collective stacking, so that, for example, an intermetallic compound (IMC) layer may be formed at the boundary between the low melting point metal layer and the second coil pattern 312.

Based on the direction of FIG. 1, the coil patterns 311 and 312 and their end portions 312-1 may protrude from the lower and upper surfaces of the support portion 210, respectively. As another example, the first coil pattern 311 and the end portion thereof may protrude from the lower surface of the support portion 210, and the second coil pattern 312 and the end portion 312-1 thereof may be embedded in the upper surface of the support portion 210, so that the upper surface of each of the second coil pattern 312 and the end portion 312-1 thereof may be exposed to the upper surface of the support portion 210. In this case, a concave portion may be formed on the upper surface of the second coil pattern 312 and/or the end portion 312-1 of the second coil pattern 312, and thus, the upper surfaces of the second coil pattern 312 and/or the end portion 312-1 of the second coil pattern 312 and the upper surface of the support portion 210 may not be coplanar. As another example, the second coil pattern 312 and the end portion 312-1 thereof may be formed to protrude from the upper surface of the support portion 210 and the first coil pattern 311 and the end portion thereof may be embedded in the lower surface of the support portion 210, so that the lower surface of each of the first coil pattern 311 and the end portion thereof may be exposed to the lower surface of the support portion 210. In this case, a concave portion may be formed on the lower surface of the first coil pattern 311 and/or the end portion of the first coil pattern 311, so that the lower surfaces of the first coil pattern 311 and/or the end portion of the first coil pattern 311 may not be coplanar with the lower surface of the support portion 210.

The via and coil patterns 311 and 312 may each be formed of a conductive material, such as copper (Cu), aluminum (Al), silver (Ag), tin (Sn), gold (Au), nickel (Ni), lead (Pb), and titanium (Ti), or alloys thereof, but are not limited thereto.

The external electrodes 400 and 500 are disposed on the surface of the body 100 and connected to both end portions 312-1 of the coil 310, respectively. In the present exemplary embodiment, both end portions 312-1 of the coil 310 extend to the first and second side surfaces 103 and 104 of the body 100, respectively. Accordingly, the first external electrode 400 may be disposed on the first side surface 103 and contact the end portion of the first coil pattern 311 extending to the first side surface 103 of the body 100, and the second external electrode 500 may be disposed on the second side surface 104 and contact the end portion 312-1 of the second coil pattern 312 extending to the second side surface 104 of the body 100.

The external electrodes 400 and 500 may extend onto the first surface 101 of the body 100. That is, the first external electrode 400 may be disposed on the first side surface 103 and the first surface 101 to form an L shape, and the second external electrode 500 may be disposed on the second side surface 104 and the first surface 101 to form an L shape.

The external electrodes 400 and 500 may be formed in a single-layer or multi-layer structure. As an example, the external electrodes 400 and 500 include a first layer including copper, a second layer disposed on the first layer and including nickel (Ni), and a third layer disposed on the second layer and including tin (Sn). Here, the first to third layers may each be formed by plating, but are not limited thereto. As another example, the external electrodes 400 and 500 may include a resin electrode including conductive powder and resin and a plating layer formed on the resin electrode.

The external electrodes 400 and 500 may be formed of a conductive material, such as copper (Cu), aluminum (Al), silver (Ag), tin (Sn), gold (Au), nickel (Ni), lead (Pb), titanium (Ti), or alloys thereof. It may be formed of a conductive material, or alloys thereof, but are not limited thereto.

Although not illustrated in the drawing, the insulating film 600 may be formed on the support member 200, the coil 310, and the metal layer 320, which will be described below. The insulating film 600 may be used to insulate the coil 310 and the metal layer 320 from the body 100 and may include a known insulating material, such as parylene. The insulating material included in the insulating film 600 may be any material, and there is no particular limitation. The insulating film 600 may be formed by a method, such as vapor deposition, but is not limited thereto, and may be formed by stacking an insulating film on both sides of the support member 200. In the former case, the insulating film 600 may be formed in the form of a conformal film along the surfaces of the support member 200, the coil 310, and the metal layer 320. Meanwhile, in the present disclosure, the insulating film 600 is optional, so if the body 100 may secure sufficient insulation resistance at an operating voltage and operating current of the coil component 1000 according to the present exemplary embodiment, the insulating film 600 may be omitted.

### Second Exemplary Embodiment

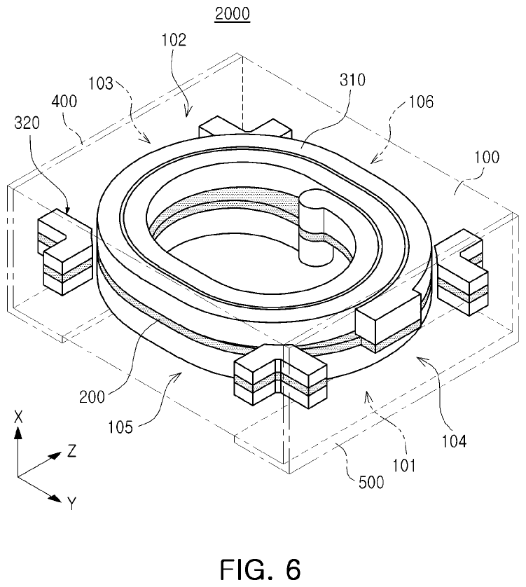

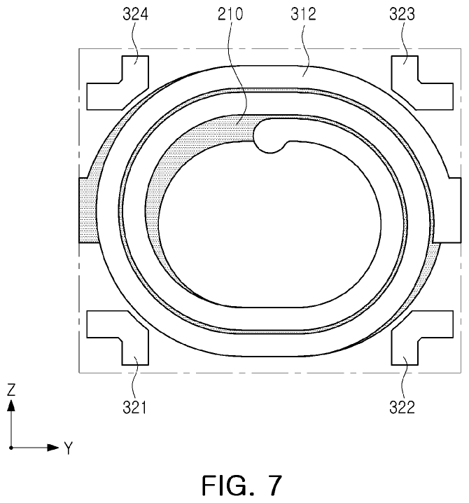

FIG. 6 is a perspective view schematically illustrating a coil component according to a second exemplary embodiment in the present disclosure. FIG. 7 is a plan view schematically illustrating the coil component according to the second exemplary embodiment in the present disclosure.

Referring to FIGS. 6 and 7, a modified example 2000 of the coil component according to the second exemplary embodiment in the present disclosure may further include a metal layer 320. The metal layer 320 may be disposed on both sides of the stopper portion 220. That is, with reference to FIG. 6, the metal layer 320 may be disposed on both the lower and upper surfaces of the stopper portion 220.

Referring to FIG. 7, the metal layer 320 may be spaced apart from the coil 310. The metal layer 320 may not be physically or electrically connected to the coil 310. Unlike the coil 310, the metal layer 320 may have a component that does not directly form inductance in the coil component.

By forming the metal layer 320 on the stopper portion 220, stress applied to the coil 310 and the support portion 210 may be further reduced when stacking the magnetic composite sheets. Specifically, flow of the magnetic composite sheet for forming the body 100 to a gap (space) between the stopper portion 220 and the corner of the body 100 may be promoted.

A plurality of metal layers 320 may be formed to be adjacent to each corner formed by a plurality of side surfaces of the body. Specifically, the metal layer 320 may include a first metal layer 321 adjacent to the corner formed by the first side surface 103 and the third side surface 105 of the body, a second metal layer 322 adjacent to the corner formed by the second side surface 104 and the third side surface 105 of the body, a third metal layer 323 adjacent to the corner formed by the second side surface 104 and the fourth side surface 106 of the body, and a fourth metal layer 324 adjacent to the corner formed by the first side surface 103 and the fourth side surface 106 of the body.

The plurality of metal layers 321, 322, 323, and 324 may be formed to be symmetrical to each other. Here, ‘symmetry’ is a concept including not only plane symmetry but also point symmetry. Referring to FIG. 7, the first metal layer 321 and the second metal layer 322 may have a plane symmetry relationship based on a plane parallel to a X-Z plane. Similarly, the fourth metal layer 324 and the third metal layer 323 may also have a plane symmetry relationship based on a plane parallel to the X-Z plane. The first metal layer 321 and the fourth metal layer 324 may have a plane symmetry relationship based on a plane parallel to an X-Y plane. Similarly, the second metal layer 322 and the third metal layer 323 may also have a plane symmetry relationship based on a plane parallel to the X-Y plane.

The metal layer 320 may have an ‘L’ shape to correspond to the shape of the stopper portion 220. Specifically, the metal layer 320 may take an L-shape to form a rectangular shape with the corner of the body 100 adjacent thereto.

The metal layer 320 may not extend to the plurality of side surfaces of the body 100. That is, the metal layer 320 may be embedded in the body 100, like the stopper portion 220 embedded in the body. In this case, it is possible to prevent the metal layer 320 from being pushed (plating spread phenomenon) during a dicing process of the coil component. However, the present disclosure is not limited thereto, and the metal layer 320 may extend to a plurality of side surfaces of the body 100.

The metal layer 320 may have a width of 30 μm or more and 500 μm or less. That is, the metal layer may be formed to have substantially the same width as the width of the stopper portion 220 described above. For a method of measuring the width of the metal layer 320, the description of the stopper portion 220 of the first exemplary embodiment may be referred to.

The metal layer 320 may be formed on the stopper portion 220 in the same process as the coil 310 forming process described above. Specifically, the metal layer 320 may include one or more conductive layers. When the conductive layer 320 is formed on the stopper portion 220 by plating, the metal layer 320 may include a seed layer, such as an electroless plating layer, and an electroplating layer. Here, the electroplating layer may have a single-layer structure or a multi-layer structure. The electroplating layer having a multi-layer structure may be formed as a conformal film structure in which one electroplating layer is covered by another electroplating layer or may also be formed such that another electroplating layer is stacked only on one surface of any one electroplating layer.

A thickness of the metal layer 320 may be substantially the same as a thickness of the coil 310. Here, the thickness refers to a length in the first direction (the X-direction) in FIGS. 6 and 7. As described above, the metal layer 320 may be formed in the same process as the coil 310 forming process, so the metal layer 320 may have the same thickness as the coil 310. The thickness of the metal layer 320 and the coil 310 may be measured by the following method. First, the coil component is polished in the second direction (the Y-direction) to prepare a cross-sectional sample exposing the metal layer 320 and the coil 310. Next, the collected cross-sectional sample may be observed using an optical microscope, or the like, and the lengths of the metal layer 320 and the coil 310 in the first direction (the X-direction) may be measured to obtain the respective thicknesses. Thickness may refer to an arithmetic average of the values obtained by measuring the lengths multiple times at multiple points in the third direction (the Z-direction). A case in which the thicknesses are substantially the same may include errors occurring during the manufacturing process and may specifically refer to a case in which the thicknesses of the metal layer 320 and the coil 310 are within an error range of +10%.

The metal layer 320 may be formed of a conductive material, such as copper (Cu), aluminum (Al), silver (Ag), tin (Sn), gold (Au), nickel (Ni), lead (Pb), titanium (Ti), or alloys thereof, but is not limited thereto.

The metal layer 320 may not be in direct contact with the external electrodes 400 and 500. As described above, the metal layer 320 may not extend to the plurality of side surfaces of the body 100, and even if the metal layer 320 extends to the plurality of side surfaces of the body 100, an insulating layer (not shown) may be disposed on the surfaces to which the metal layer 320 extends, so that the metal layer 320 may not be in direct contact with the electrodes 400 and 500.

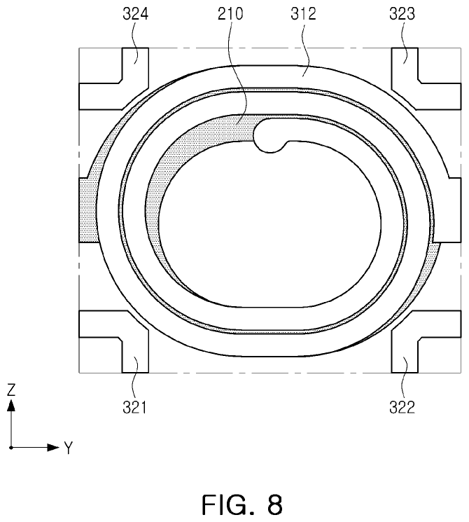

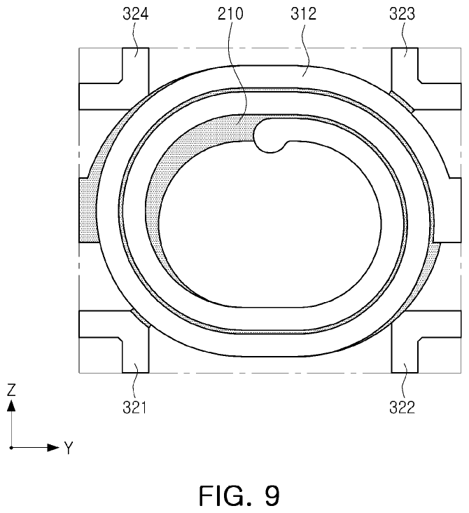

FIG. 8 is a plan view illustrating a modified example of the coil component according to the second exemplary embodiment in the present disclosure. FIG. 9 is a plan view illustrating another modified example of the coil component according to the second exemplary embodiment in the present disclosure.

Referring to FIGS. 8 and 9, the metal layer 320 may extend to a plurality of side surfaces 103, 104, 105, and 106 of the body. Specifically, the metal layer 320 may extend to any two adjacent side surfaces among the plurality of side surfaces 103, 104, 105, and 106 of the body. More specifically, the metal layer 320 may extend to the first side surface 103 and the third side surface 105, may extend to the second side surface 104 and the third side surface 105, may extend to the second side surface 103 and the fourth side surface 106, and may extend to the first side surface 103 and the fourth side surface 106. That is, the metal layer 320 may also extend to any two adjacent side surfaces among the plurality of side surfaces of the body 100 along the shape of the stopper portion 220.

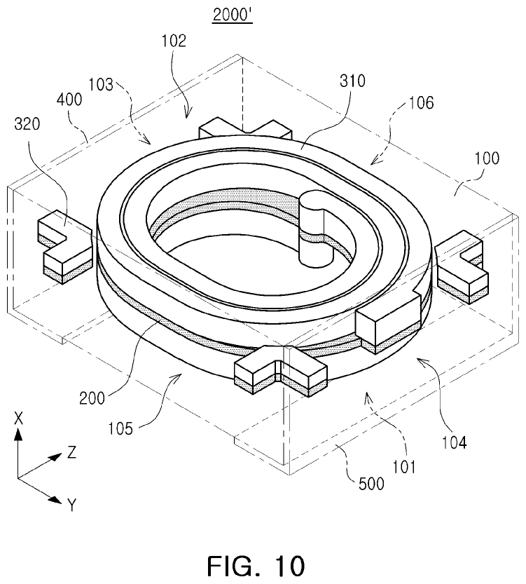

FIG. 10 is a perspective view illustrating another modified example of the coil component according to the second exemplary embodiment in the present disclosure.

Referring to FIG. 10, in a modified example of the coil component according to the second exemplary embodiment in the present disclosure, the metal layer 320 may be disposed on only one side of the stopper portion 220. That is, with reference to FIG. 10, the metal layer 320 may be disposed only on the upper surface of the stopper portion 220. However, the present disclosure is not limited thereto, and the metal layer 320 may be disposed only on the lower surface of the stopper portion 220.

For the remaining components of the present exemplary embodiment, the description in the first exemplary embodiment in the present disclosure may be applied as is, and the detailed description thereof is redundant and will be omitted below.

According to the present disclosure, it is possible to prevent the coil from being deformed during the process of stacking and compressing magnetic composite sheets.

In addition, according to the present disclosure, a defect rate due to deformation of the coil may be reduced, while forming the coil component to be thinner (low-profile).

While example exemplary embodiments have been illustrated and described above, it will be apparent to those skilled in the art that modifications and variations could be made without departing from the scope of the present disclosure as defined by the appended claims.

What is claimed is:

1. A coil component comprising:
a body having a first surface, a second surface opposing the first surface in a first direction, and a plurality of side surfaces connecting the first surface and the second surface;
a coil embedded in the body; and
a support member embedded in the body and including a support portion supporting the coil and at least one stopper portion disposed at a corner formed by two or more of the plurality of side surfaces of the body in an outer region of the support portion.

2. The coil component of claim 1, wherein the stopper portion has an ‘L’ shape to have a rectangular shape with an adjacent corner of the body.

3. The coil component of claim 1, wherein a portion of the body is disposed between the stopper portion and an adjacent corner of the body.

4. The coil component of claim 1, wherein the stopper portion is formed in plural to be adjacent to each corner formed by the plurality of side surfaces of the body.

5. The coil component of claim 4, wherein the plurality of stopper portions are symmetrical to each other.

6. The coil component of claim 1, wherein the stopper portion extends to the two or more of the plurality of side surfaces of the body.

7. The coil component of claim 1, wherein the stopper portion is connected to the support portion.

8. The coil component of claim 1, wherein the stopper portion is spaced apart from the support portion.

9. The coil component of claim 1, wherein the stopper portion has a width of 30 μm or more and 500 μm or less.

10. The coil component of claim 1, further comprising:
a metal layer disposed on at least one surface of the stopper portion,
wherein the metal layer is spaced apart from the coil.

11. The coil component of claim 10, wherein the metal layer extends to the two or more of the plurality of side surfaces of the body.

12. The coil component of claim 10, wherein a thickness of the metal layer is substantially the same as a thickness of the coil.

13. The coil component of claim 10, further comprising an insulating film disposed on the metal layer and the coil and covering the metal layer and the coil.

14. The coil component of claim 1, wherein the coil includes:
a first coil pattern having a planar spiral shape disposed on one surface of the support portion;
a second coil pattern having a planar spiral shape disposed on the other surface opposing the one surface of the support member; and
a via passing through the support portion to connect the first and second coil patterns.

15. The coil component of claim 1, wherein end portions of the coil extend to side surfaces of the body opposing each other in a second direction of the body, respectively, among the plurality of side surfaces of the body.

16. The coil component of claim 1, further comprising:
first and second external electrodes respectively disposed on side surfaces of the body opposing each other in a second direction of the body, among the plurality of side surfaces of the body, and respectively connected to end portions of the coil.

17. The coil component of claim 16, wherein the first and second external electrodes extend to the first surface of the body.

18. The coil component of claim 1, wherein the stopper portion includes a first portion extending toward one of the two or more of the plurality of side surfaces of the body, a second portion extending toward another of the two or more of the plurality of side surfaces of the body, and a connection portion connecting the first portion and the second portion to each other and disposed closer to the support member than the first and second portions.

19. The coil component of claim 18, wherein the first portion is in contact with the one of the two or more of the plurality of side surfaces of the body, and the second portion is in contact with the another of the two or more of the plurality of side surfaces of the body.

20. The coil component of claim 18, wherein the first portion is spaced apart from the one of the two or more of the plurality of side surfaces of the body, and the second portion is spaced apart from the another of the two or more of the plurality of side surfaces of the body.
